(19) United States
(12) Patent Application Publication
(10) Pub. No.: US 2016/0280430 A1
(43) Pub. Date: Sep. 29, 2016

(54) LID FOR A CONTAINER, A CONTAINER AND A METHOD FOR MANUFACTURING THE CONTAINER

(71) Applicant: Cogito Et Creo Ltd, Wanchai (HK)

(72) Inventor: Chris Petlikovski, Mangerton (AU)

(73) Assignee: Cogito Et Creo Ltd, Wanchai (HK)

(21) Appl. No.: 15/076,047

(22) Filed: Mar. 21, 2016

(30) Foreign Application Priority Data
Mar. 23, 2015 (AU) 2015901039
Aug. 3, 2015 (AU) 2015903089

(51) Int. Cl. B65D 51/32; B65D 51/28; A47J 43/044; B01F 7/26; B01F 15/00; B65D 25/28; B01F 7/18

(52) U.S. Cl. CPC B65D 51/32; B65D 25/28; B65D 51/2835; B01F 7/18; B01F 7/26; B01F 15/00779; A47J 43/044

(57) ABSTRACT

A lid for a container includes an attachment portion arranged to attach the lid to the container. There is a lid portion integrally formed with the attachment portion and sized to substantially cover an opening in the container. It also includes at least one opening located on the lid portion to allow the ingress or egress of fluid from the container when the lid is in situ, and at least one arm extending from the lid portion and arranged, in use, to locate within the container to stir the contents of the container.

### FIELD OF THE INVENTION

The present invention relates to a lid for a container, a container and a method for manufacturing the container. Embodiments of the invention find particular, but not exclusive, use as a container for beverages, such as tea, coffee and other liquids. It will be understood, however, that other embodiments may find use in other applications such as a lid for a container and a container for solid food or liquid and/or solid non-food substances.

### BACKGROUND OF THE INVENTION

Coffee and other beverages are available in so-called ‘take-away’ or ‘take-out’ containers. Such containers generally consist of a cup or receptacle, with a lid. The cup and lid are commonly made from a material such as cardboard, waxed paper, plastic, Styrofoam™ or some other form of formable yet inexpensive material. Such cups and lids are generally made in a way to allow for easy disposal.

It is common for people to purchase take-away coffee, tea or another hot beverages for consumption while they are walking, travelling in a vehicle or otherwise moving from one location to another. In such circumstances, the lid prevents the beverage from spilling out of the container as the person moves or as their vehicle moves. However, where a take-away container includes a lid, the lid must be removed to add other ingredients, such as liquids or solids to the beverage (e.g. adding milk and sugar to coffee). Moreover, when another liquid or solid is added to the beverage, it is commonly necessary to stir the beverage to mix the added ingredients into the beverage.

Where a person is carrying the beverage or the beverage is in a vehicle that is moving, removing the lid can be awkward and give rise to a dangerous situation, particularly if the beverage spills and is hot.

It is against this background that the invention has been developed.

### SUMMARY OF THE INVENTION

In a first aspect of the invention, there is provided a lid for a container comprising an attachment portion arranged to attach the lid to the container, a lid portion integrally formed with the attachment portion and sized to substantially cover an opening in the container, at least one opening located on the lid portion to allow the ingress or egress of fluid from the container when the lid is in situ, and at least one arm extending from the lid portion and arranged, in use, to locate within the container to stir the contents of the container.

In one embodiment, the at least one arm extends includes at least one protrusion, wherein the at least one protrusion has a surface area, such that, in use, the surface area is arranged to assist in stirring the contents of the container.

The arm may be attached to a handle wherein a user may operate the handle to operate the arm and in turn stir the contents of the container.

The protrusion is substantially disc-shaped.

In one embodiment, the protrusion is angled to maximise the area swept by the arm.

In one embodiment, the arm and the protrusion cooperate such that, as the swivel is turned, the protrusion moves along the arm.

At least one opening may be arranged to receive at least receptacle arranged to, in use, to dispense a substance into the contents of the container.

The container lid may include at least one opening arranged to, in use, allow the contents of the container to be dispensed while the lid is secured to the container.

In a second aspect of the invention, there is provided a container comprising a body portion and a lid in accordance with the first aspect of the invention, wherein the lid is arranged to engage with the body portion to provide a substantially sealed container.

In a third aspect of the invention, there is provided a method of manufacturing a lid in accordance with the first aspect of the invention, comprising the steps of moulding the lid portion integrally with the attachment portion, and securing the at least one arm to the lid portion such that the arm portion extends from the lid portion.

In a fourth aspect of the invention, there is provided a lid for a container comprising an attachment portion arranged to attach the lid to the container, a lid portion integrally formed with the attachment portion and sized to substantially cover an opening in the container, at least one opening located on the lid portion to allow the ingress or egress of fluid from the container when the lid is in situ, and another opening arranged, in use, to allow a stirring mechanism to be located through the opening and into the container to stir the contents of the container.

In one embodiment of the fourth aspect, the stirring mechanism includes at least one arm arranged to extend into the container, and at least one protrusion, wherein the at least one protrusion is arranged to locate the stirring mechanism in the another opening.

In one embodiment of the fourth aspect, the arm includes a widened portion arranged to assist in the stirring motion when the stirring mechanism is operated.

In a fifth aspect of the invention, there is provided a lid for a container comprising an attachment portion arranged to attach the lid to the container, a lid portion integrally formed with the attachment portion and sized to substantially cover an opening in the container, at least one opening located on the lid portion to allow the ingress or egress of fluid from the container when the lid is in situ, and at least one compartment arranged to contain at least one substance capable of being dispensed into the container.

In one embodiment of the fifth aspect, the at least one compartment includes a piercing portion arranged to, on pressure being applied by a user, pierce a rupturable portion the compartment to allow the at least one substance to be dispensed into the container.

In one embodiment of the fifth aspect, the rupturable portion is constructed of a foil-like substance.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1a and 1b are diagrams illustrating an example embodiment of the present invention.

FIGS. 2a and 2b are diagrams illustrating an alternate embodiment of the present invention.

FIG. 3 is a diagram illustrating the embodiment of FIGS. 1a and 1b ‘in situ’.

FIG. 4 is a diagram illustrating the embodiment of FIGS. 2a and 2b ‘in situ’.

FIGS. 5a and 5b illustrate a feature which may be applied to any embodiment of the present invention.

FIGS. 6 and 6a illustrate an example embodiment of the present invention.

FIGS. 7, 7a and 7b illustrates a stirring mechanism in accordance with an embodiment of the present invention.

FIGS. 8 through 17b illustrate alternative embodiments of the present invention.

### DETAILED DESCRIPTION OF EMBODIMENTS OF THE INVENTION

A description of example embodiments of the invention follows.

In the ensuing description, reference is made to a “coffee cup”. Such references are directed to a specific commercial embodiment of the invention and are described as a “coffee cup” merely to provide the reader with an illustrative example and a context for one embodiment of the invention. No gloss is to be taken from the use of a specific described use of the embodiment or from any commercial example of an embodiment of the invention to limit the scope of the embodiments and claimed invention as described and defined herein. In other words, it will be understood that the example embodiments described herein are illustrative only.

The embodiments described herein generally provide a lid for a container. The lid includes an attachment portion arranged to attach the lid to the container and a lid portion integrally formed with the attachment portion and sized to substantially cover an opening in the container. The lid portion includes at least one opening located on the lid portion to allow the ingress or egress of fluid from the container when the lid is in situ. There is also provided at least one arm extending from the lid portion and arranged, in use, to locate within the container to stir the contents of the container.

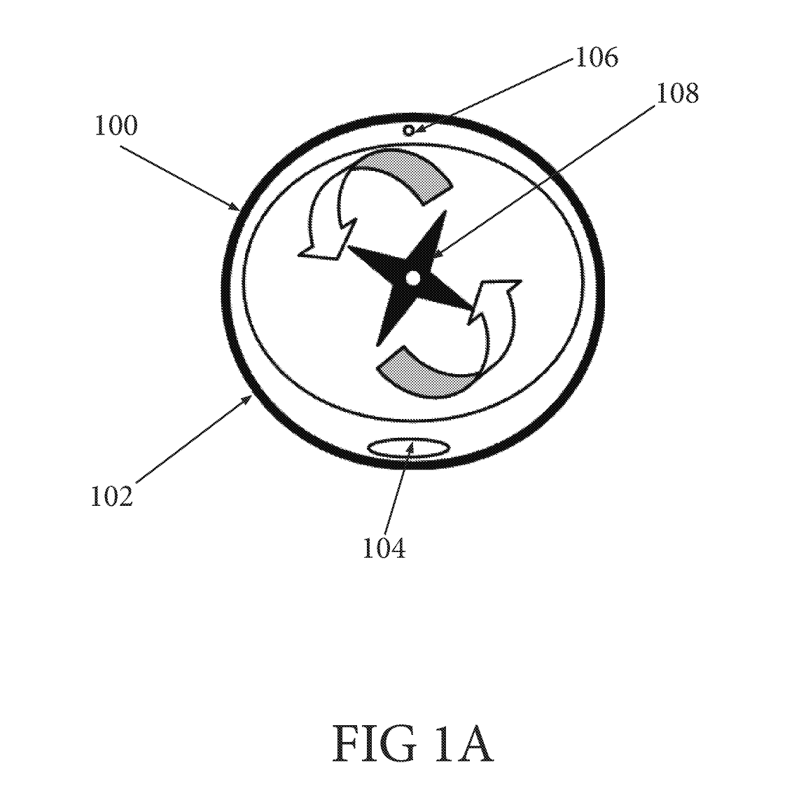

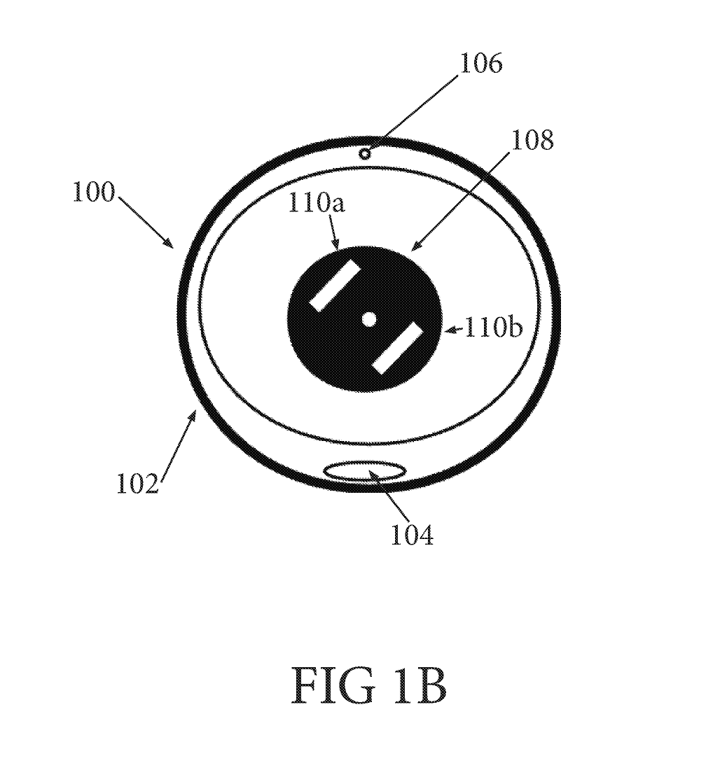

In one embodiment and with reference generally to FIGS. 1a and 1b, there is shown a container lid 100. FIG. 1a illustrates a top view of the embodiment and FIG. 1b illustrates a bottom view of the embodiment. The lid 100 includes an attachment portion 102 and at least one opening 104 through which liquid may pass through the lid. There may also be provided a vent 106.

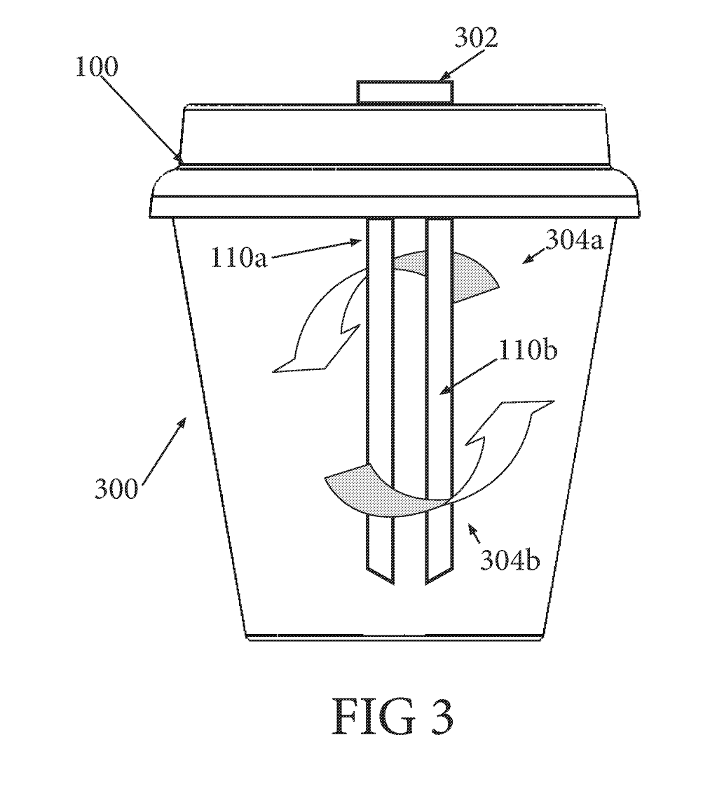

There is also provided a rotatable hub mechanism 108 which includes two arms 110a and 110b that extend down from the lid and are arranged to extend, in use, into a container, such as a coffee cup (as described in more detail later with reference to FIG. 3).

The rotatable hub mechanism 108 may also include a handle portion (not shown in FIGS. 1a and 1b) which is connected, either directly or indirectly, to the two arms, such that operation of the handle results in operation of the two arms (i.e. rotation of the handle causes the two arms to rotate).

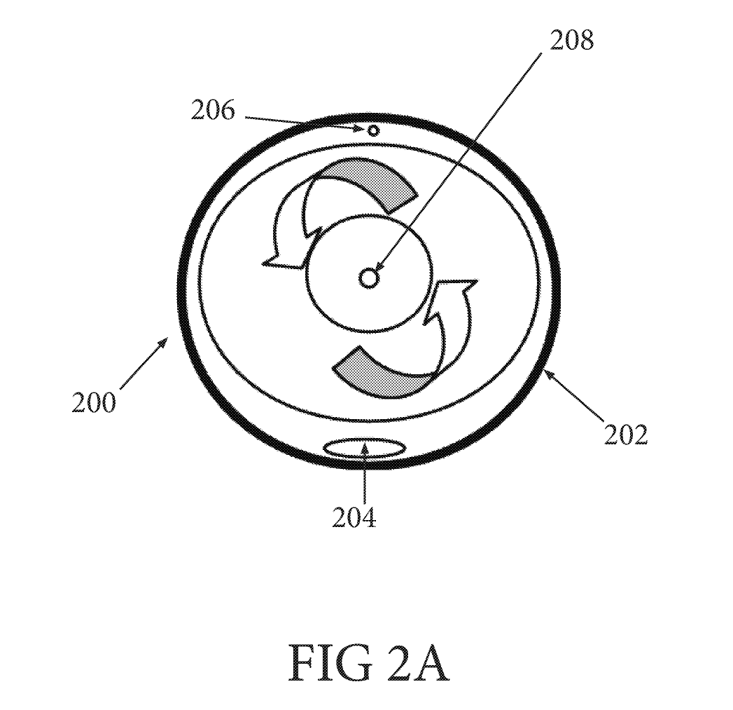

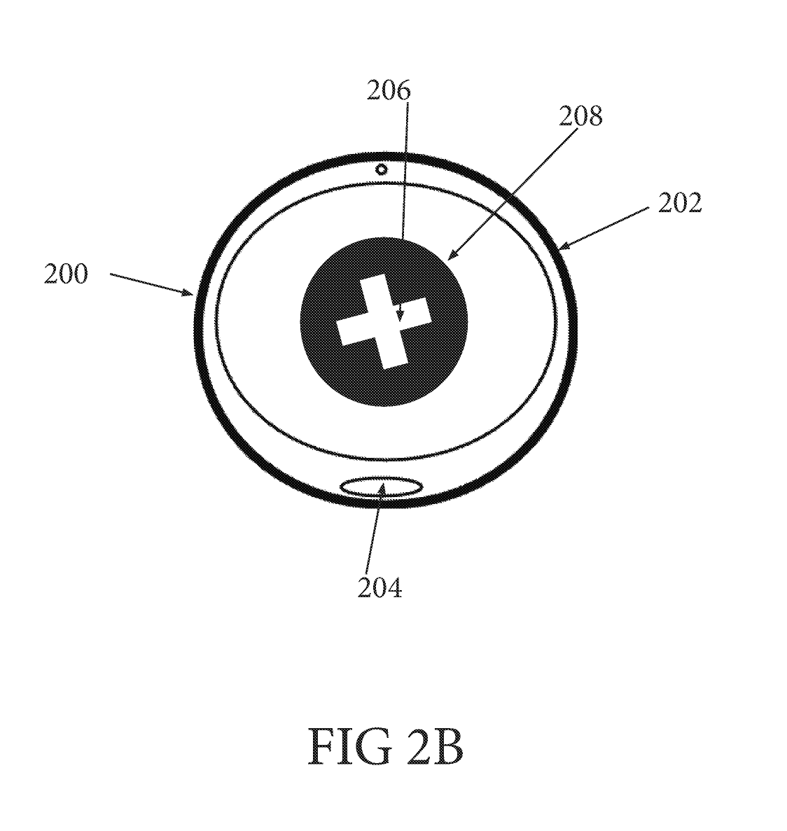

In another embodiment and with reference generally to FIGS. 2a and 2b, there is shown a container lid 200, which is arranged to function in a similar manner as the container lid 100 of FIGS. 1a and 1b, but which incorporates different structural features to achieve a similar function. FIG. 2a illustrates a top view of the embodiment and FIG. 2b illustrates a bottom view of the embodiment. The lid 200 includes an attachment portion 202 and at least one opening 204 through which liquid may pass through the lid. There may also be provided a vent 206.

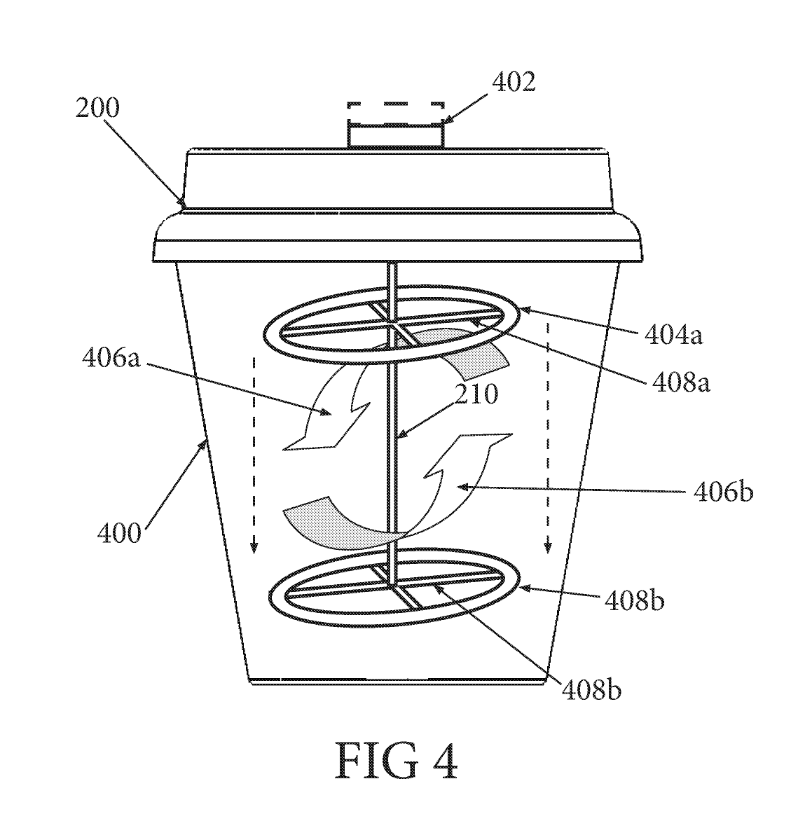

There is also provided a rotatable hub mechanism 208 which includes a single arm 210 that extend down from the lid and are arranged to extend, in use, into a container, such as a coffee cup (as described in more detail later with reference to FIG. 4). Extending from the single arm 210 is at least one disc portion (not shown in FIGS. 2a and 2b but shown in FIG. 4) which is arranged to rotate about the single arm 210. The at least one disc portion may be angled relative to the at least one arm 210, such that the at least one disc portion, upon rotation of the arm, describes a cylindrical volume about the one arm.

The rotatable hub mechanism 208 may also include a handle portion (not shown in FIGS. 2a and 2b) which is connected, either directly or indirectly, to the two arms, such that operation of the handle results in operation of the two arms (i.e. rotation of the handle causes the two arms to rotate).

FIG. 3 illustrates the embodiment of FIGS. 1a and 1b ‘in situ’. That is, the lid portion 100 is arranged to sealingly fit over a cup 300, such that the two arms 110a and 110b locate within the cup 300. When the handle 302 is rotated, the arms 110a and 110b rotate within the container 300 and describe a volume within the container, such that, if the container is filled with a liquid, the arms 110a and 110b ‘mix’ or ‘stir’ the liquid, as illustrated by the arrows 304a and 304b.

FIG. 4 illustrates the embodiment of FIGS. 2a and 2b ‘in situ’. That is, the lid portion 200 is arranged to sealingly fit over a cup 400, such that the arm 210 locates within the cup 400. When the handle 402 is rotated, the arm 210 and the two discs 404a and 404 b rotate within the container 400 and describe a volume within the container, such that, if the container is filled with a liquid, the discs 404a and 404b ‘mix’ or ‘stir’ the liquid, as illustrated by the arrows 406a and 406b.

Optionally, the two discs 404a and 404b may include some hollow portions 408a and 408b, which aid in mixing the liquid by provided an extra flow path as denoted by the dotted arrows in FIG. 4. It will also be understood that the discs may be angled to maximise the area swept by the arm, thereby creating the most efficient mixing of the liquid.

In another embodiment, not shown in the Figures, the single arm may include a corkscrew (or similar) mechanism such that, as the arm is turned, the two discs move along the arm, thereby aiding mixing.

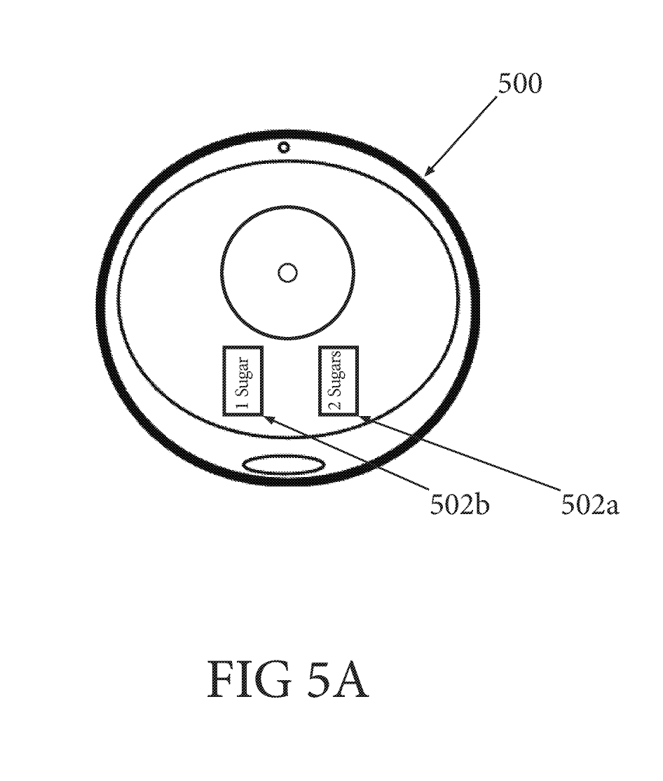

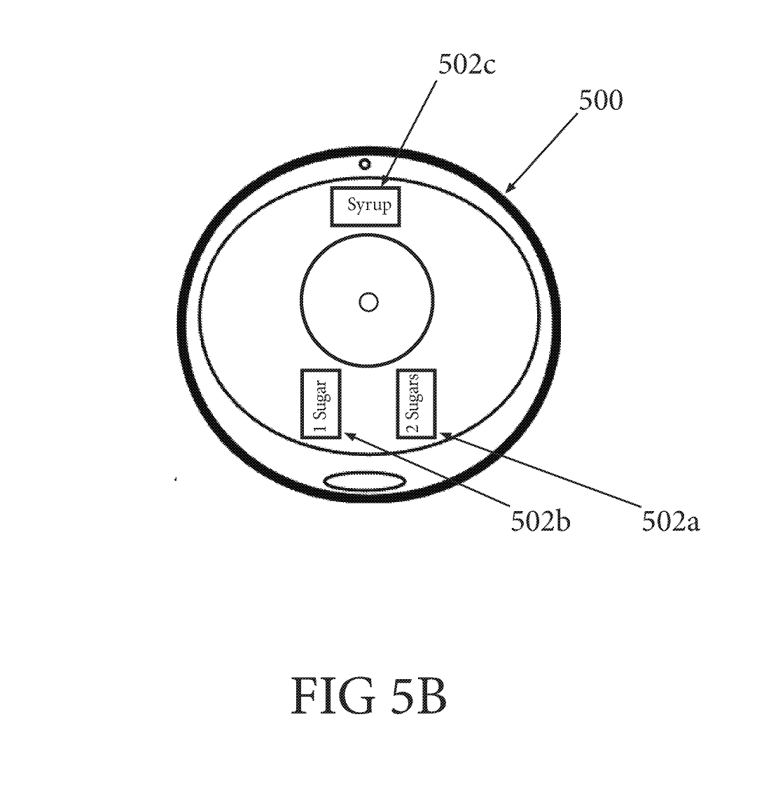

The container lid may include at least one opening arranged to, in use, allow the contents of the container to be dispensed while the lid is secured to the container. FIGS. 5a and 5b illustrate a feature that may be incorporated into either of the embodiments previously described.

The container lid 500 may include one or more sachets or dispensing portions 502a, 502b, 502c, etc., which may be arranged to hold and dispense a liquid or a solid, such as milk, creamer, sugar or a sweetener.

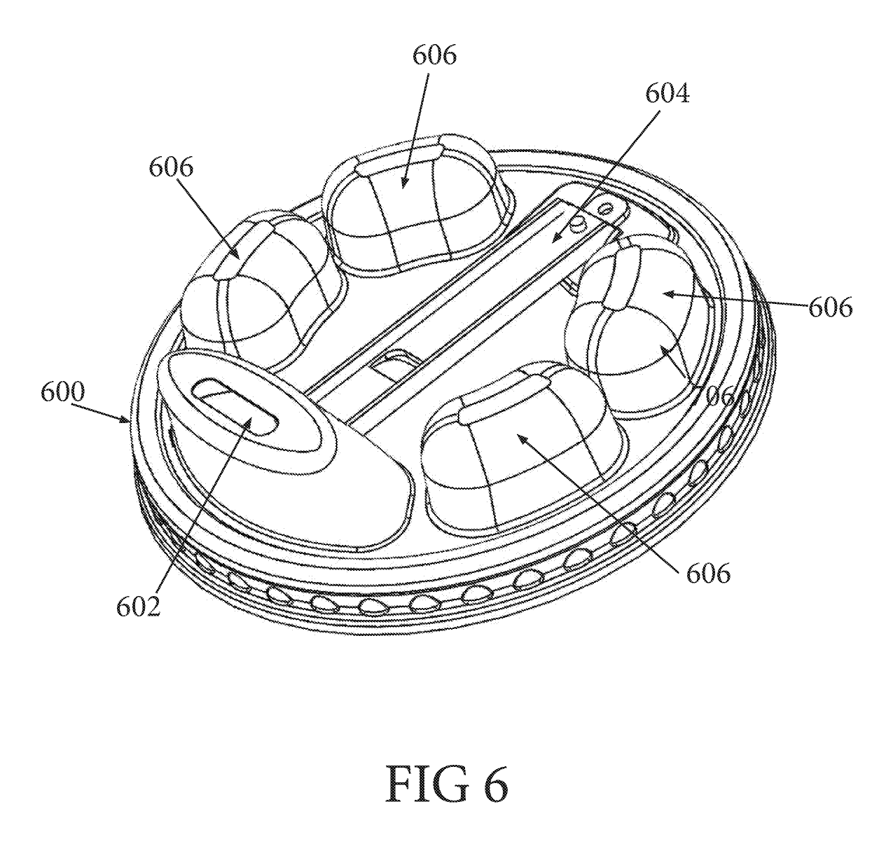

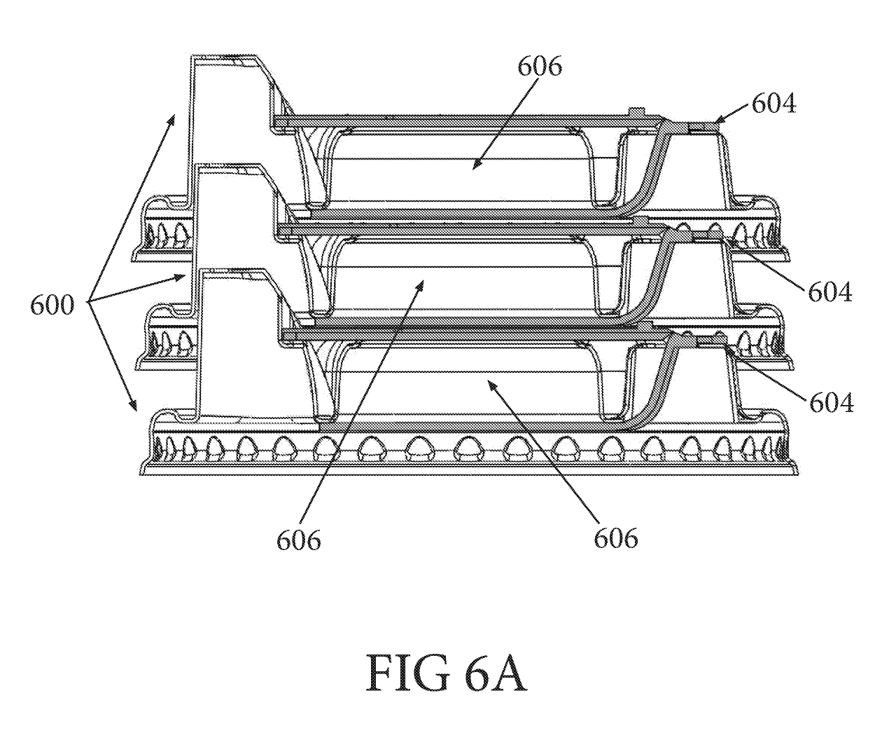

Referring now to FIGS. 6 and 6a, there is shown an additional embodiment of the invention. In the embodiment of FIGS. 6 and 6a, there is provided a container lid 600 which includes an opening 602. The openng 602 is similar to known openings in prior art container lids and is known as an opening that allows a user to drink or pour liquid from a container which has the container lid secured to it, without needing to remove the lid.

In the lid 600 of FIGS. 6 and 6a, the opening 602 also serves an additional purpose. The opening 602 is sized to receive a stirrer 604 (shown in a folded up confriguration in FIGS. 6 and 6a). The stirrer 604 is removably secured to the lid 600 and can be removed, unfolded, and slid through the opening 602 to allow the user to stir or mix the liquid in the container (not shown).

Moreover, the lid 600 includes a plurality of compartments 606, which can be filled with a suitable substance (e.g. milk, sugar, etc.) to allow a user to add the substance in the compartment 606 to the container (not shown).

Referring specifically to FIG. 6a, a plurality of lids 600 are shown in a stacked configuration. It will be

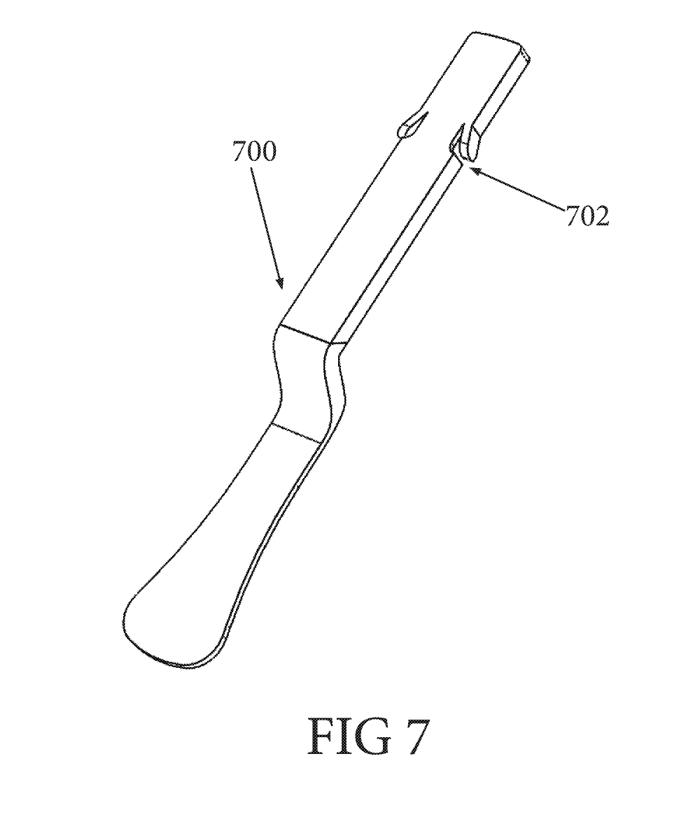

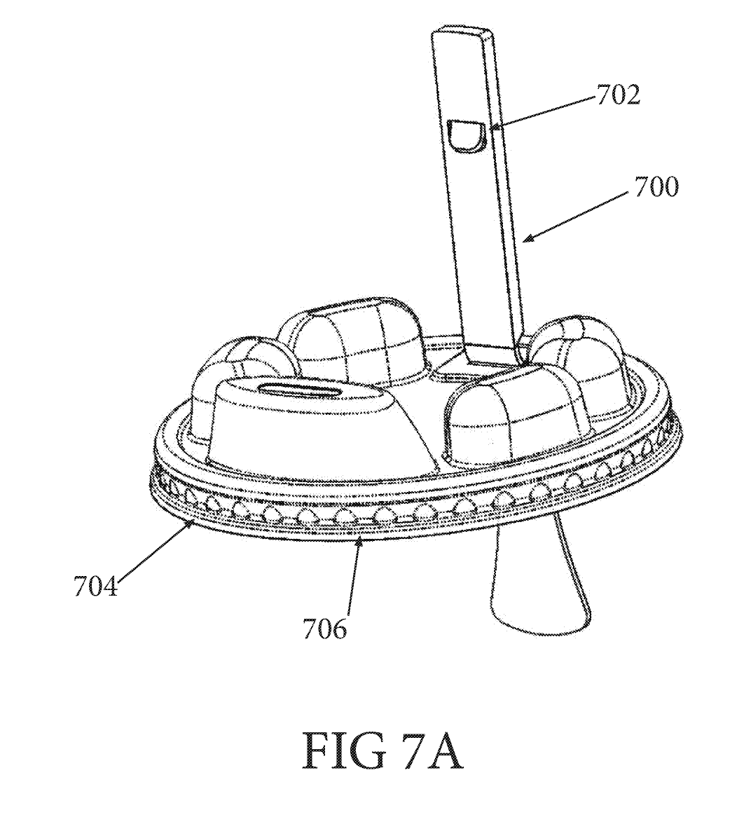

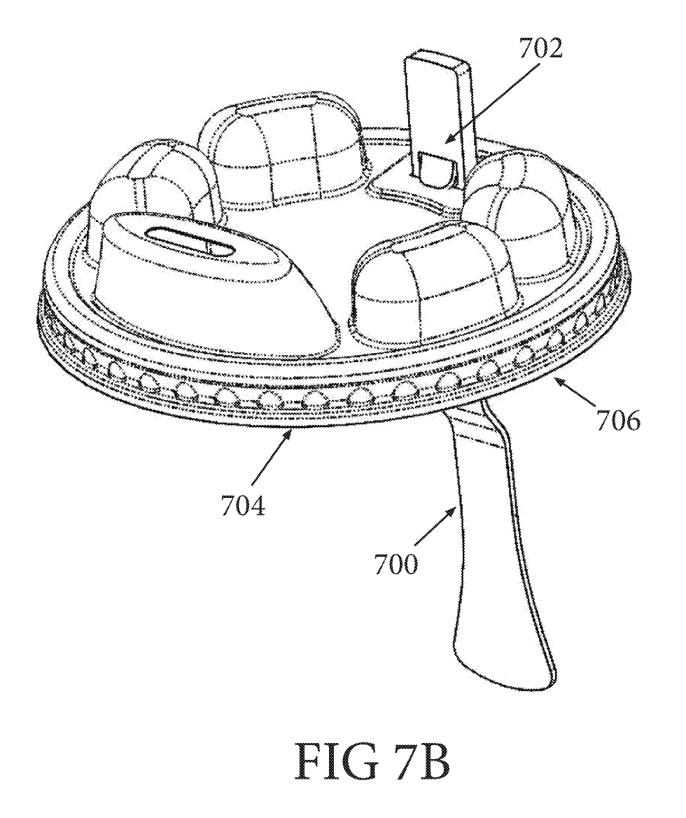

Turing to FIG. 7, there is shown a stirrer 700 which is useable with a lid such as the lid shown in FIGS. 6 and 6a. The stirrer 700 is shown in an unfolded configuration. The stirrer 700 includes a tab 702 which prevents the stirrer from ‘falling’ into the container when it is placed through an opening in the container lid (such as lid 600 of FIGS. 6 and 6a).

Examples of the container being placed into an opening are shown in FIGS. 7a and 7b, where stirrer 700 is inserted into a container lid 704 and the tab 702 cannot pass beyond a lid rin 706.

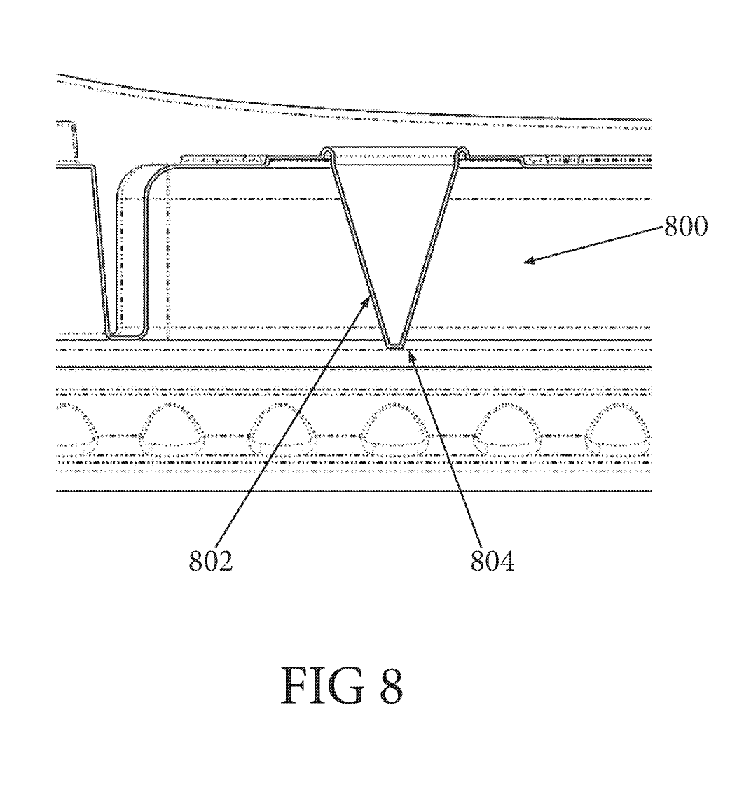

Referring now to FIG. 8, there is shown a cut-away view of a compartment 800 (equivalent in function to compartment 606 of FIGS. 6a and 6a). The compartment 800 includes a piercing portion 802 which is arranged to pierce a lower foil covering 804 of the compartment 800, so that the substance contained within the compartment 800 is allowed to flow out of the compartment 800.

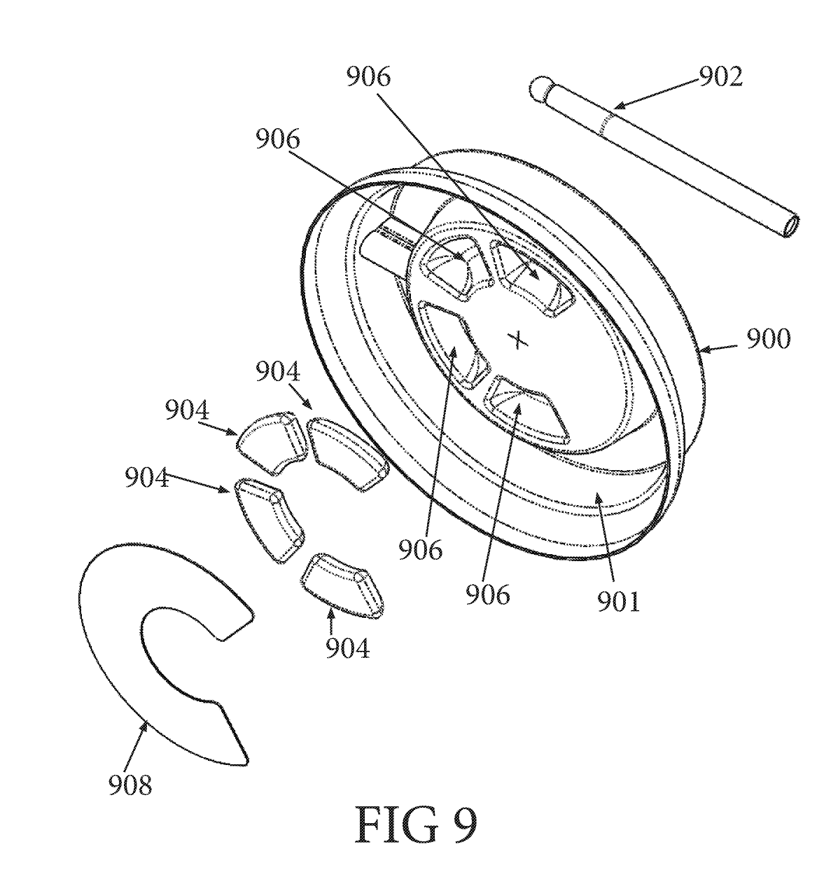

Referring now to FIG. 9, there is shown an exploded view of yet another embodiment of the invention. A container lid 900 includes a lid portion 901, a removably securable stirring apparatus 902, a series of series of substance portions (such as sugar, powdered milk, etc.) 904 arranged to locate in a series of compartments 906 and a foil covering 908 which, in manufacture, is secured over the compartments 906 after the substance portions 904 have been placed into the compartments 906.

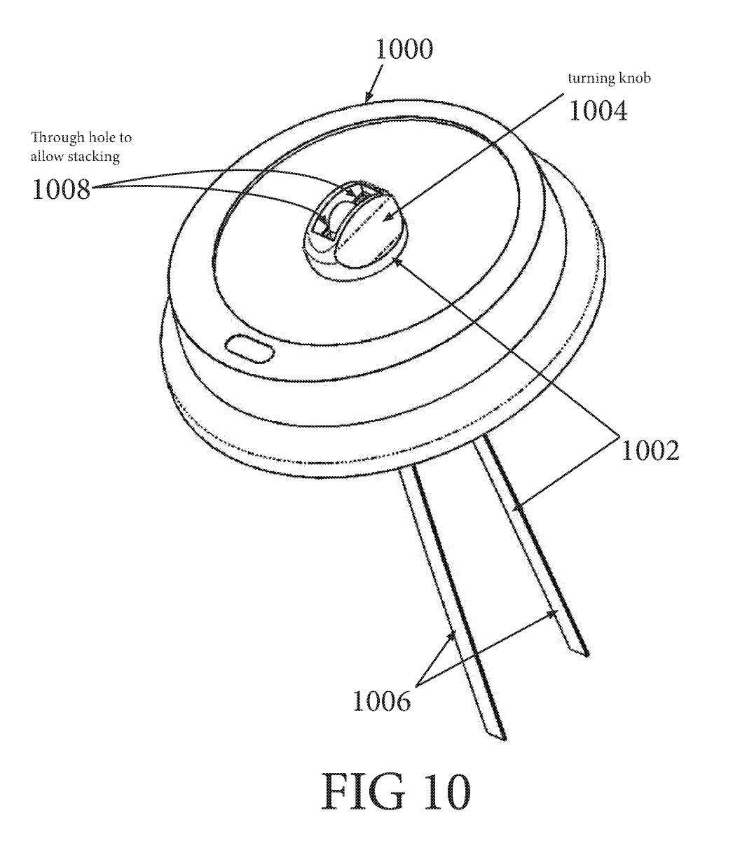

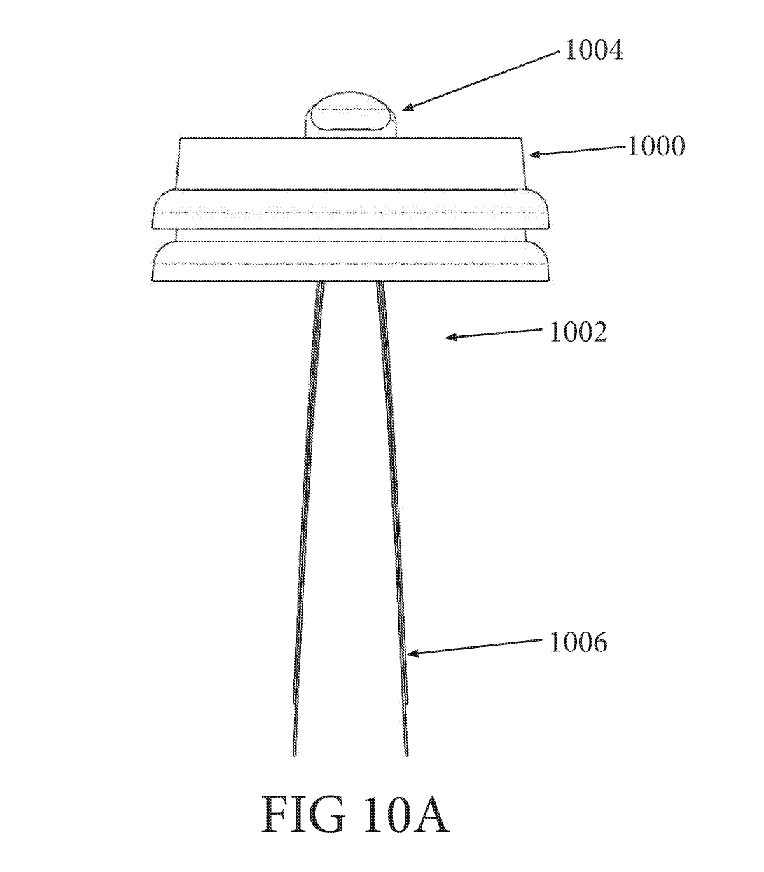

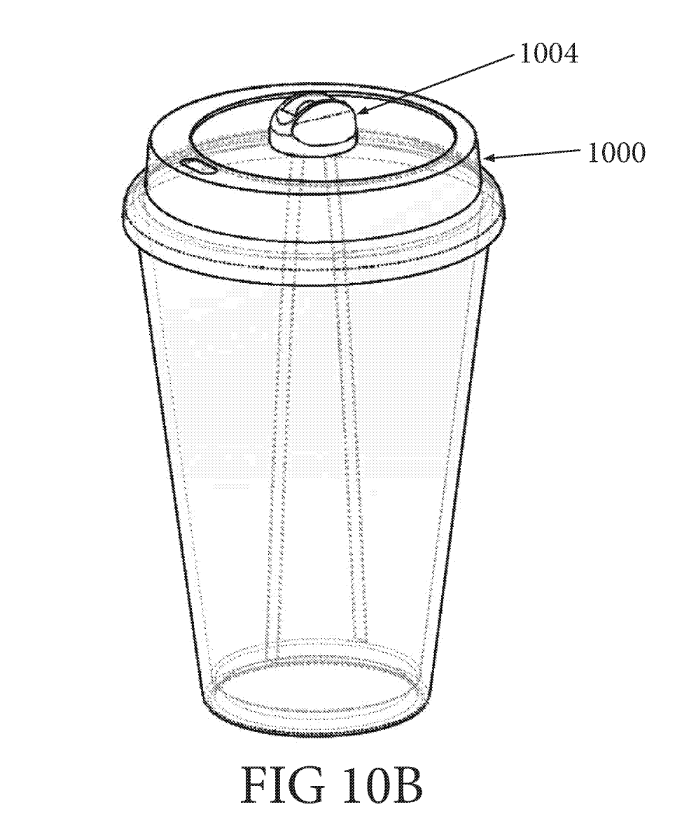

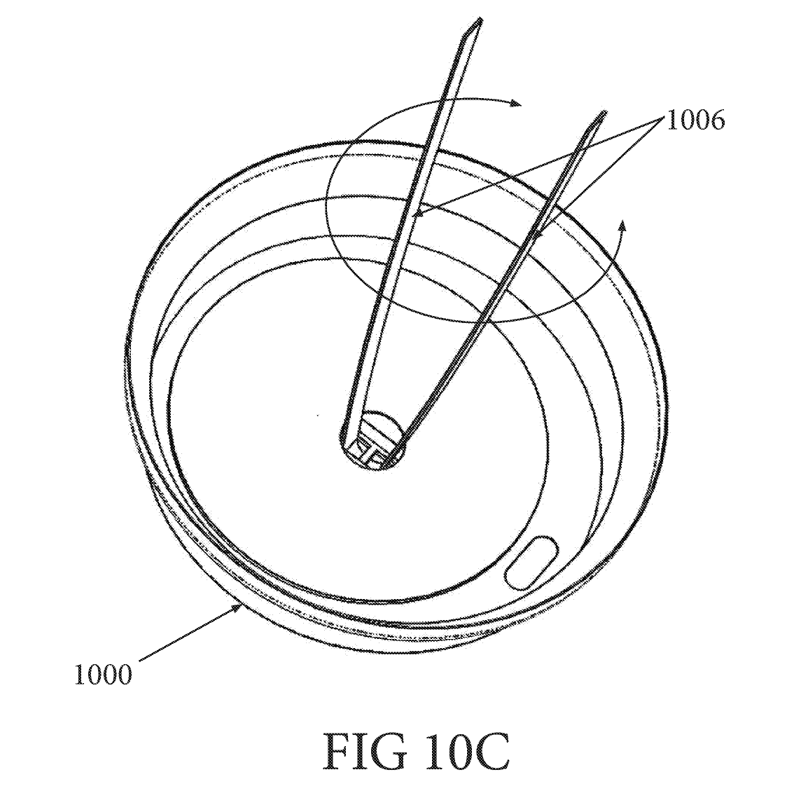

In yet another embodiment, as depicted in FIGS. 10, 10a, 10b and 10c, there is shown a container lid 1000, including a stirrer 1002 including a turning knob 1004 and stirring portions 1006 that extend downwards from the lid 1000. The Turning knob 1004 including a plurality of holes 1008 arranged to allow the lids to be stacked, by allowing the stirring portions 1006 of each successive lid to be “threaded through” the holes 1008.

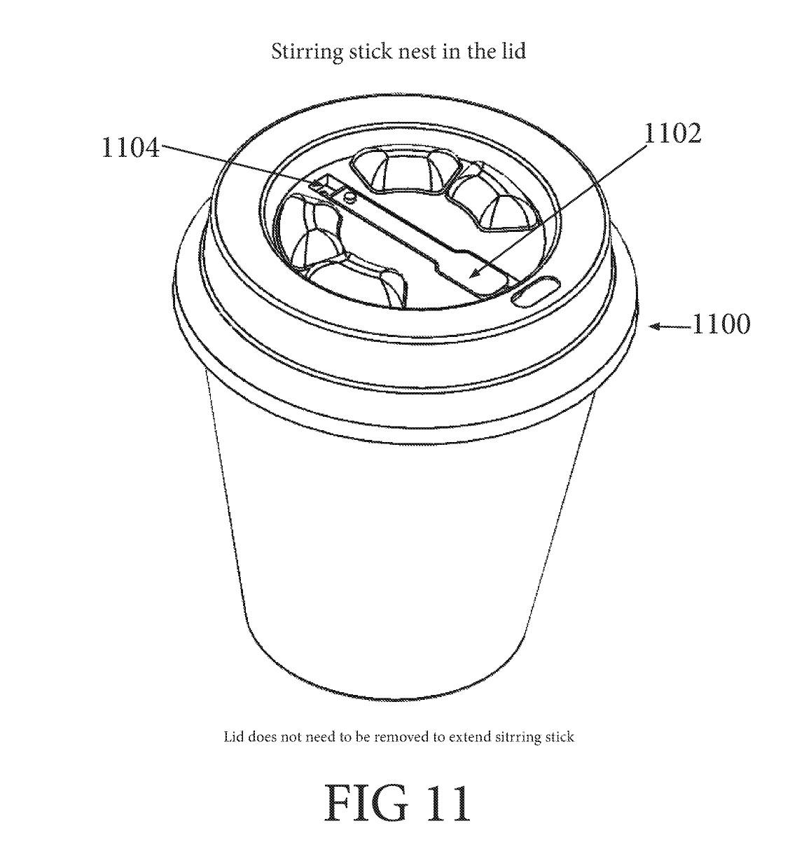

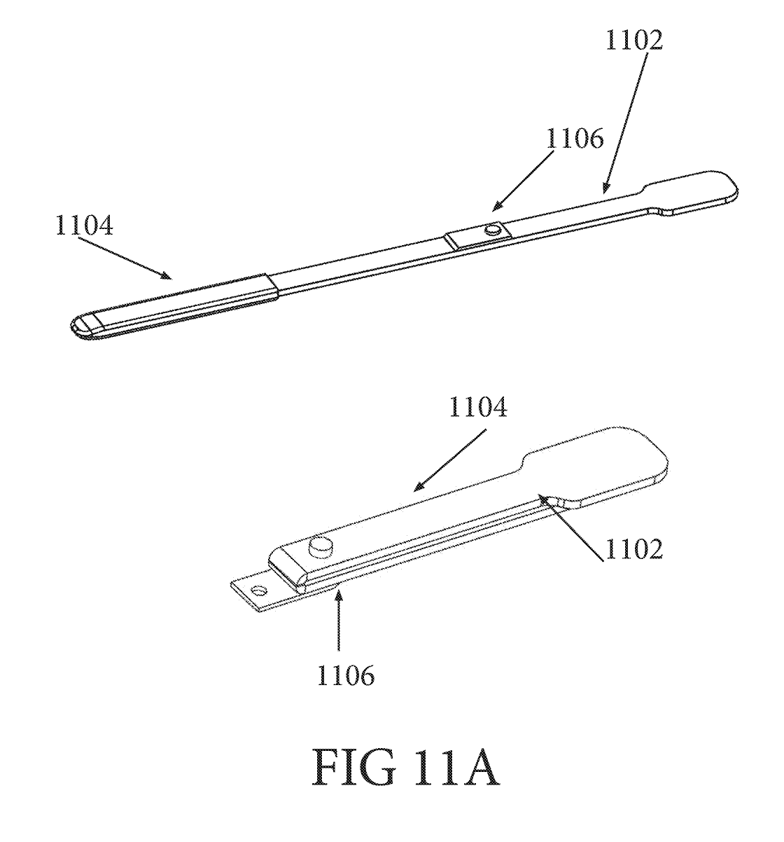

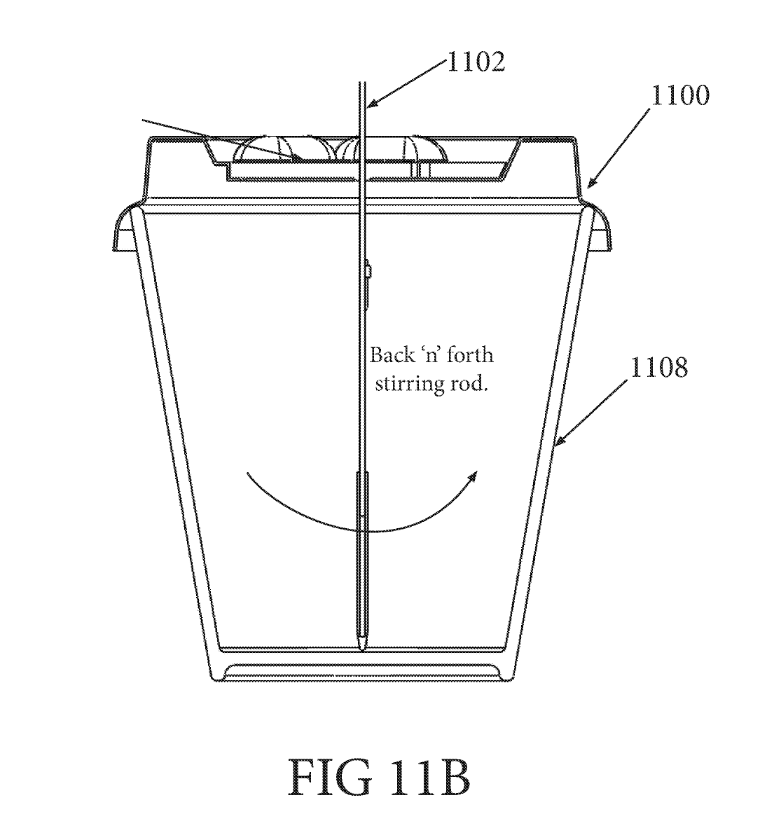

Turning to FIG. 11, there is shown a variation on the embodiment of FIGS. 6 and 6a, where the lid 1100 includes a stirrer 1102 which is arranged to nestle within a shaped depression 1104 in the lid 1100. The stirrer 1102 is shown in more detail in FIG. 11a, and includes at least two portions 1104 and 1106 arranged to fold and extend the stirrer. The stirrer is also shown in situ in a container 1108 in FIG. 11b.

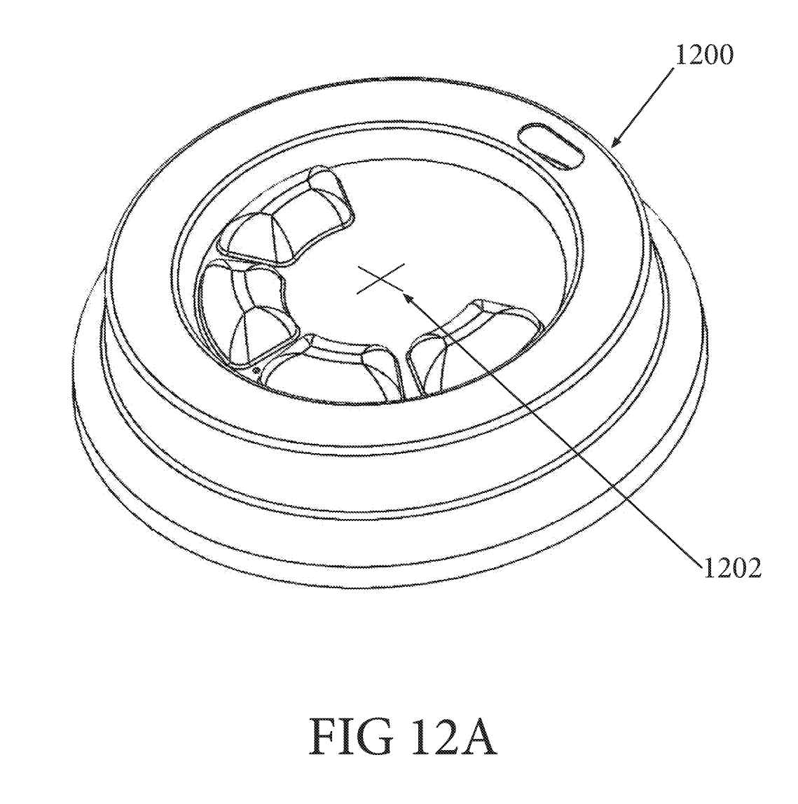

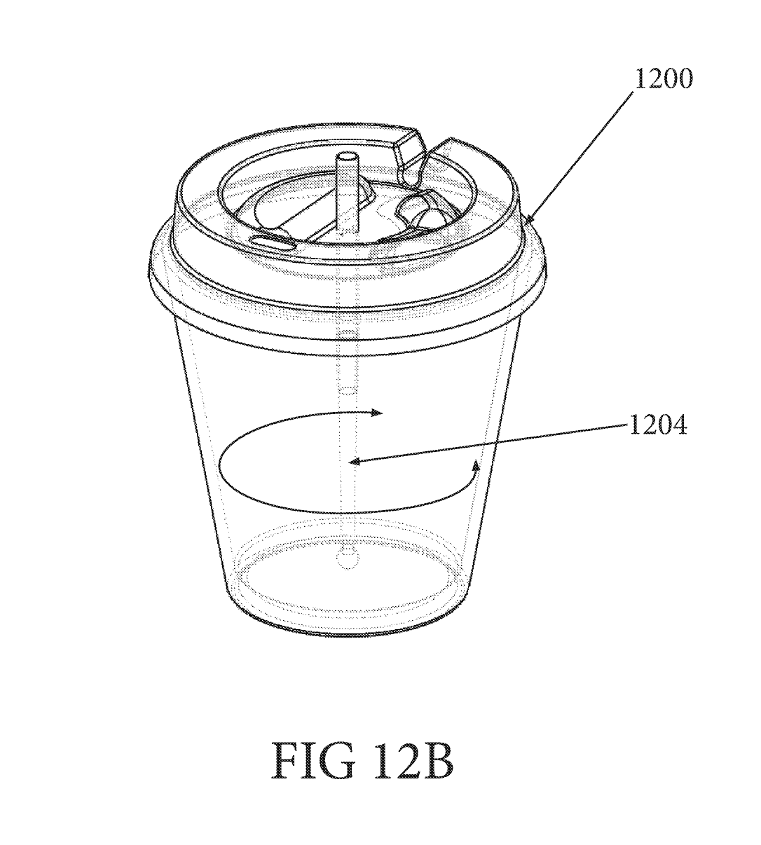

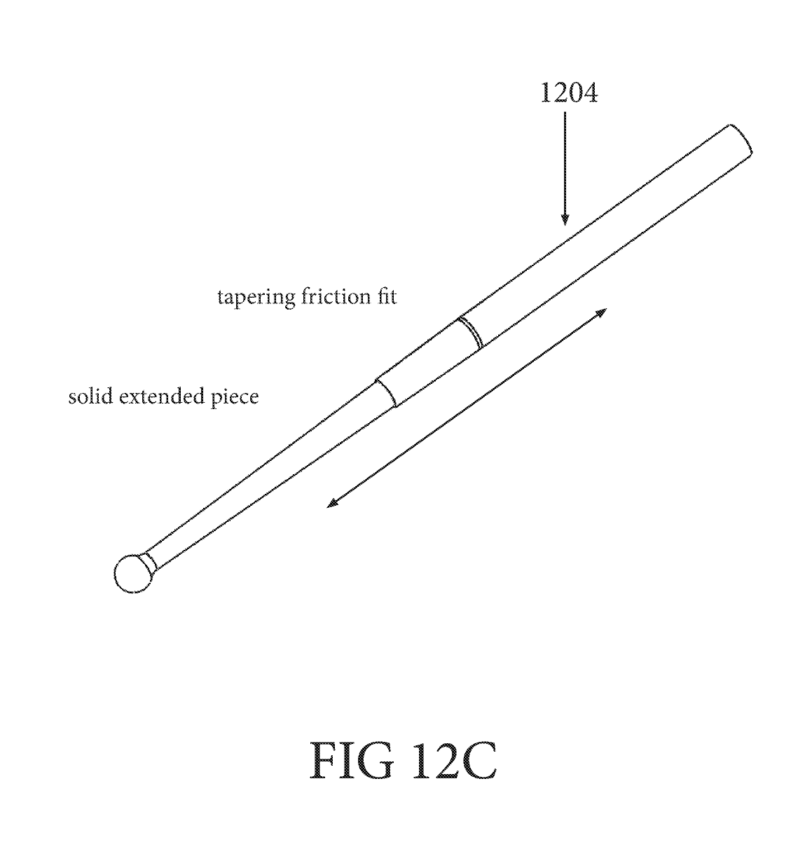

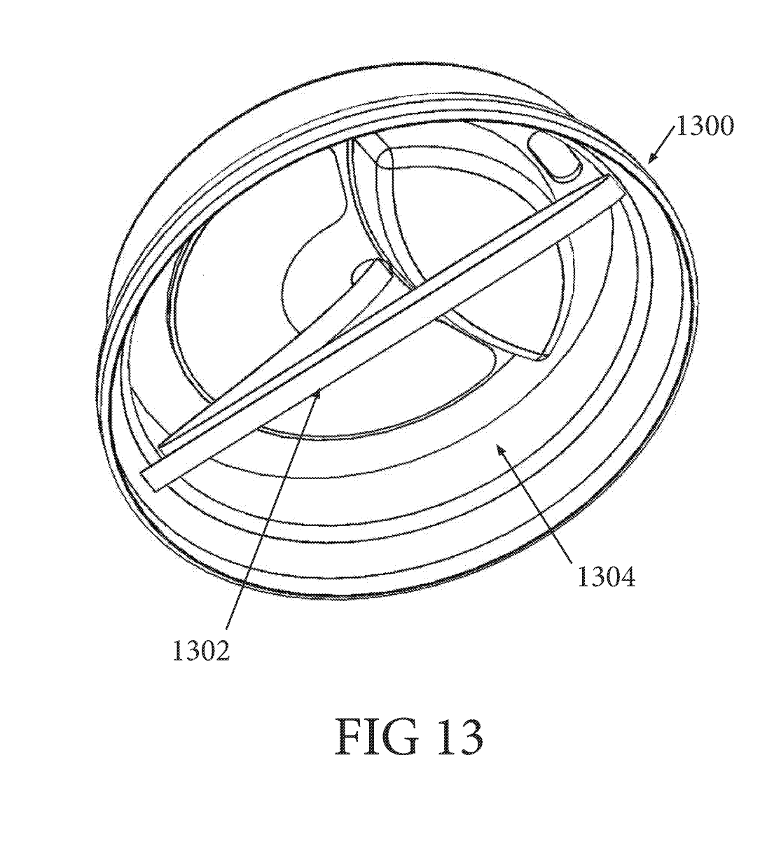

Turning to FIG. 12a, there is shown an embodiment of a lid 1200 that includes a weakened region 1202 which has a ‘self-sealing’ function and into which a stirrer may be inserted. The weakended region 1202 is arranged to provide a sealing surface to prevent spillage of a liquid from the weakened region. It will be understood that the sealing may be provided in any suitable manner, such as by using a resilient plastic product which partially overlapping portions (not shown in FIG. 12), so that once a stirrer is removed, the weakended region closes.

As shown in FIG. 12b, the weakened region is arranged to receive a stirrer 1204. As shown in FIG. 12c, the stirrer 1204 may, in one embodiment, be telescopic.

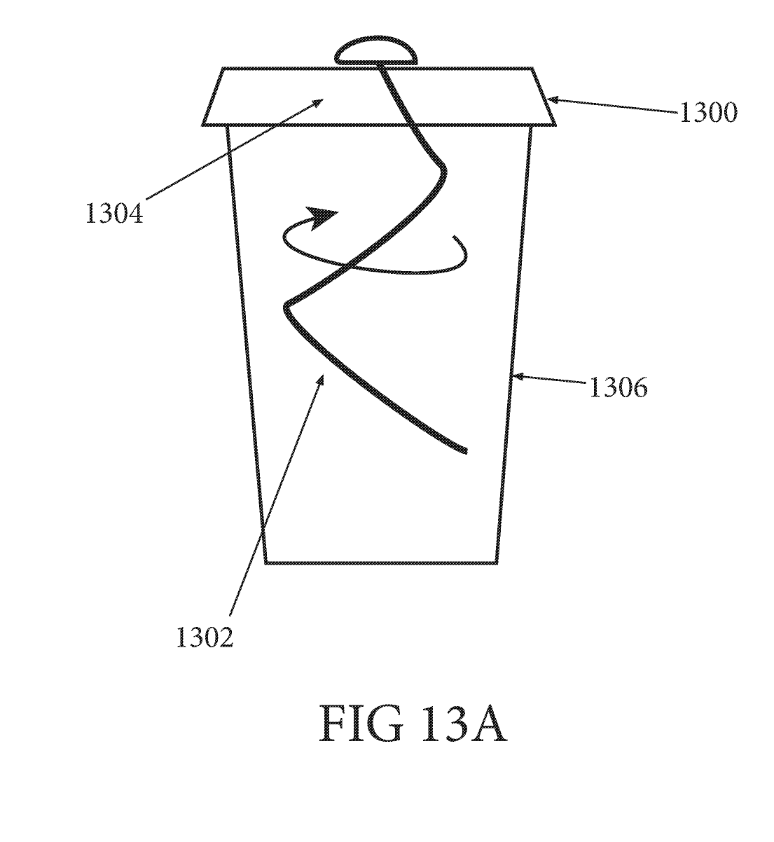

Turning to FIG. 13, there is shown a lid 1300 which includes a foldable stirrer 1302, wherein the stirrer is arranged to fold within an inner lid portion 1304 of the lid 1300.

Upon unfolding the stirrer 1302, the stirrer extends into a container 1306 as shown in FIG. 13a.

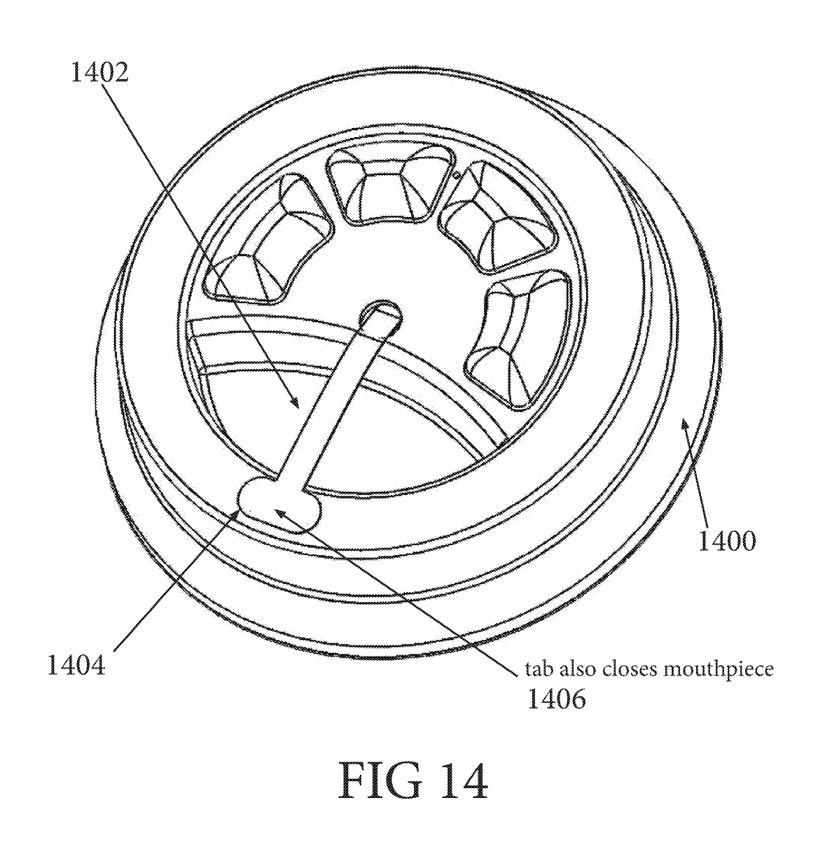

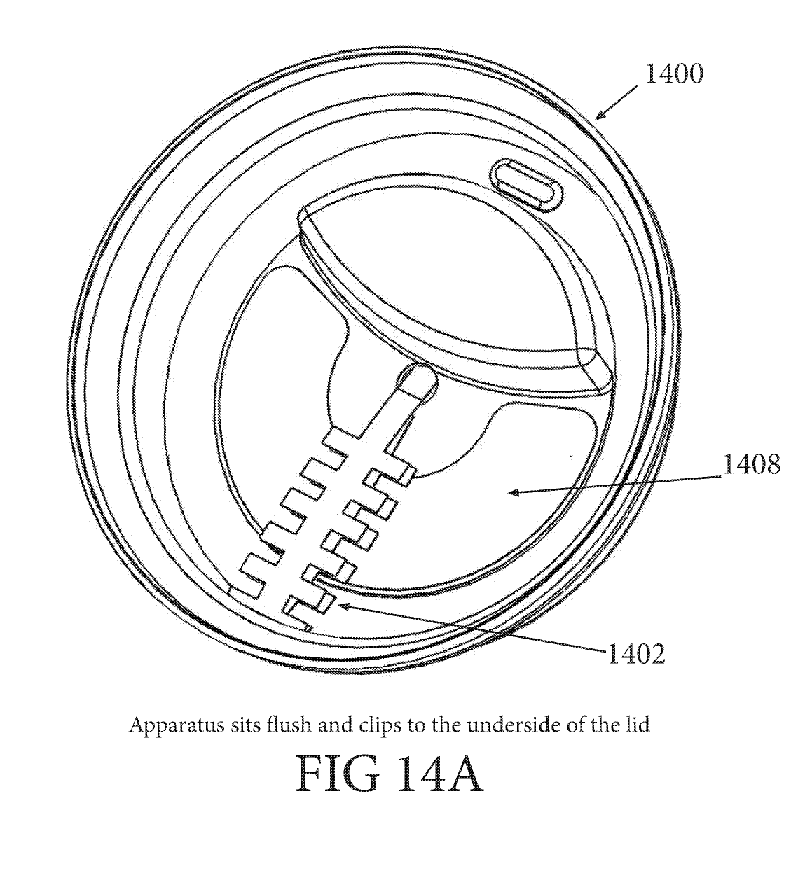

Referring now to FIG. 14, there is shown a lid 1400 which includes a stirrer 1402, which arranged with an end portion 1404 arranged to locate and seal an opening 1406. In other words, the stirrer 1402 doubles as a seal for the opening 1406. In one embodiment, the stirrer 1402 is arranged to fold within an inner lid portion 1408 of the lid 1400, as shown in FIG. 14a.

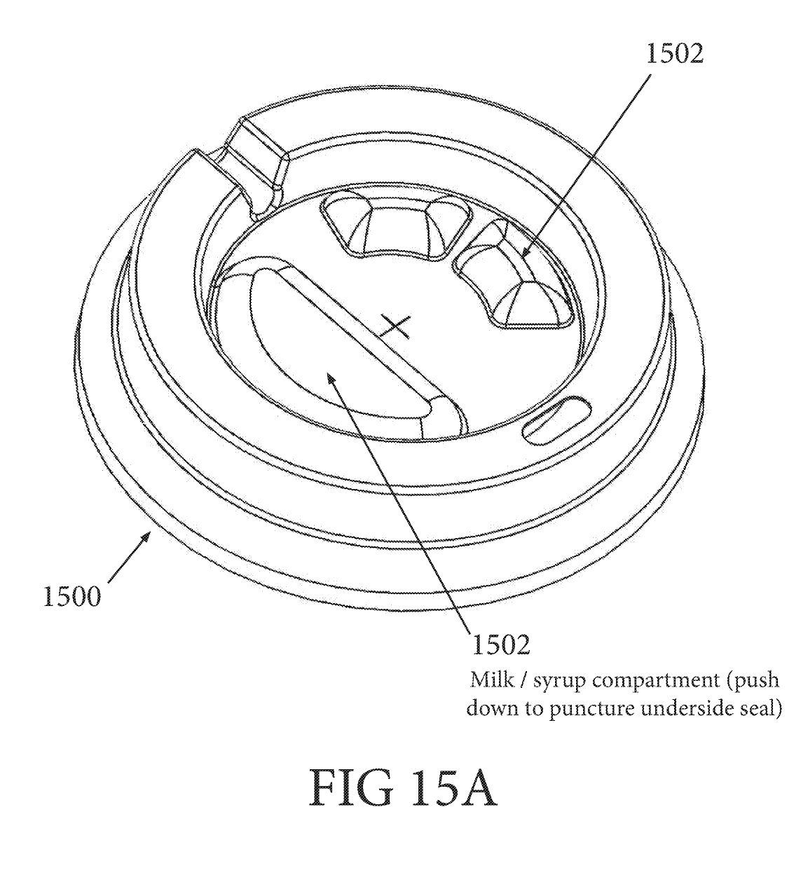

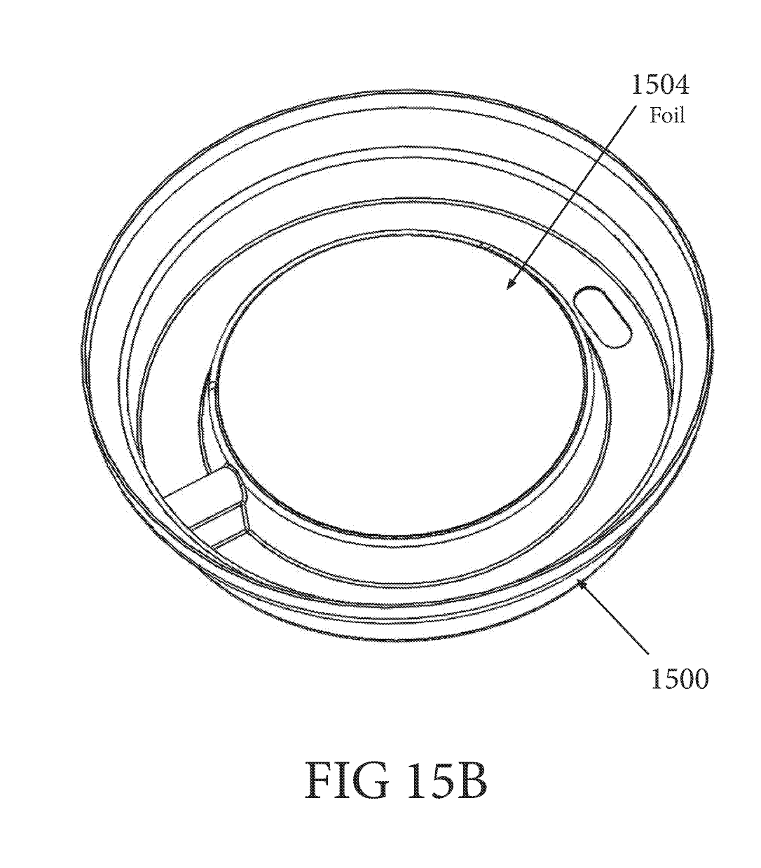

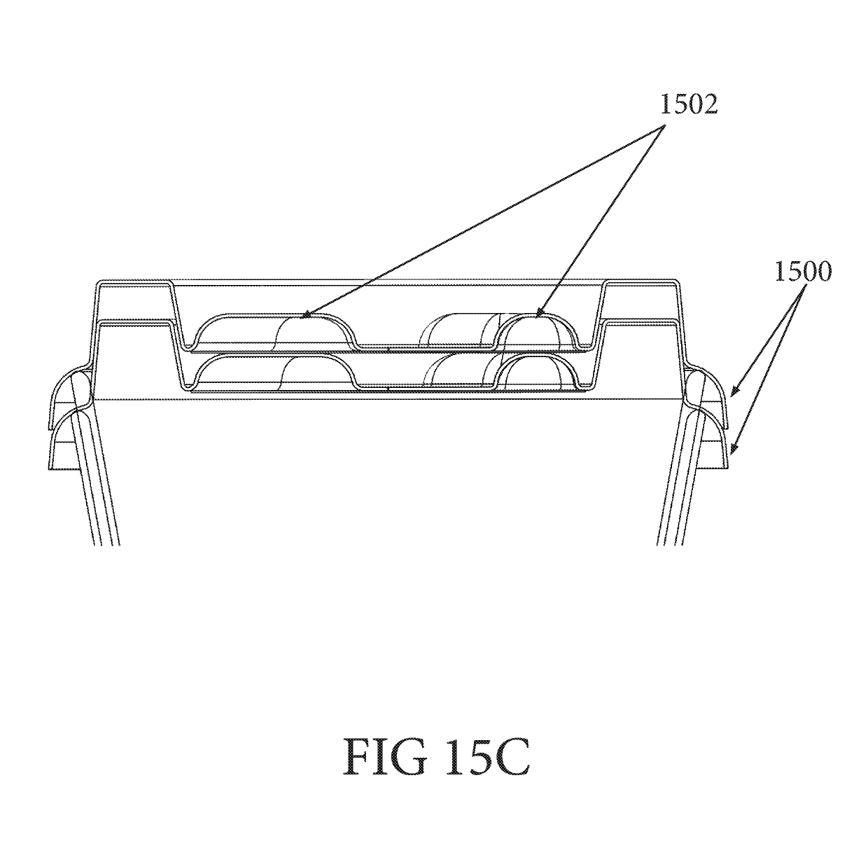

At FIGS. 15a through 15c, there is shown an alternative embodiment of the invention. Lid 1500 includes a series of compartments 1502, the compartments being arranged to hold a substance, such as a liquid or a solid. The compartments 1502 are rupturable, so that in use, a user may rupture the compartment 1502 to add the contents of the compartment to a container (not shown). The compartments 1502 may be temporarily sealed by use of a soft and rupturable material, such as foil 1504.

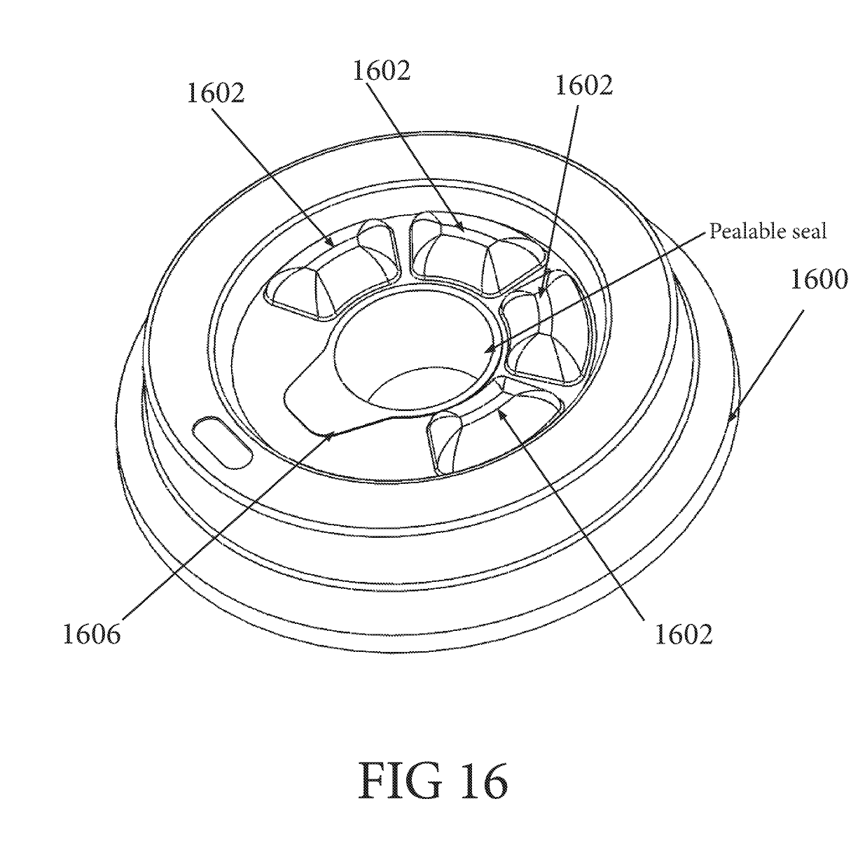

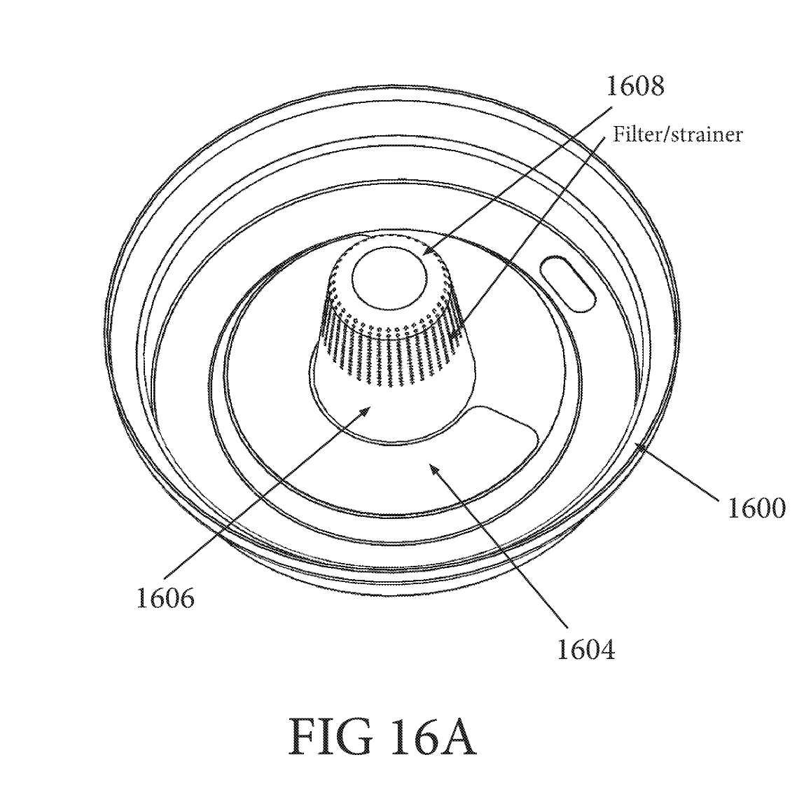

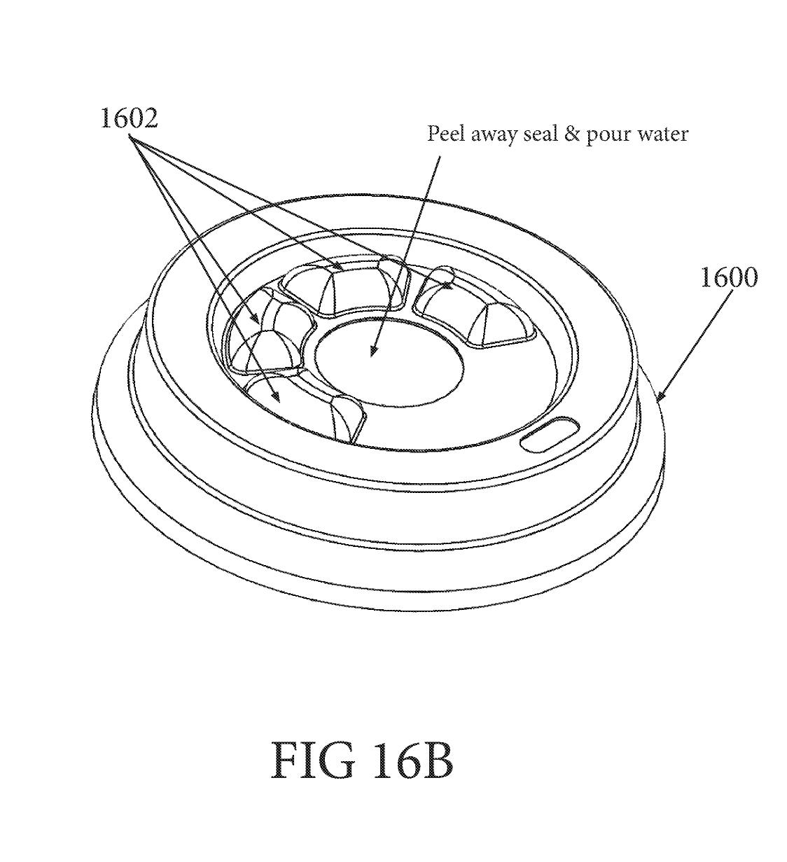

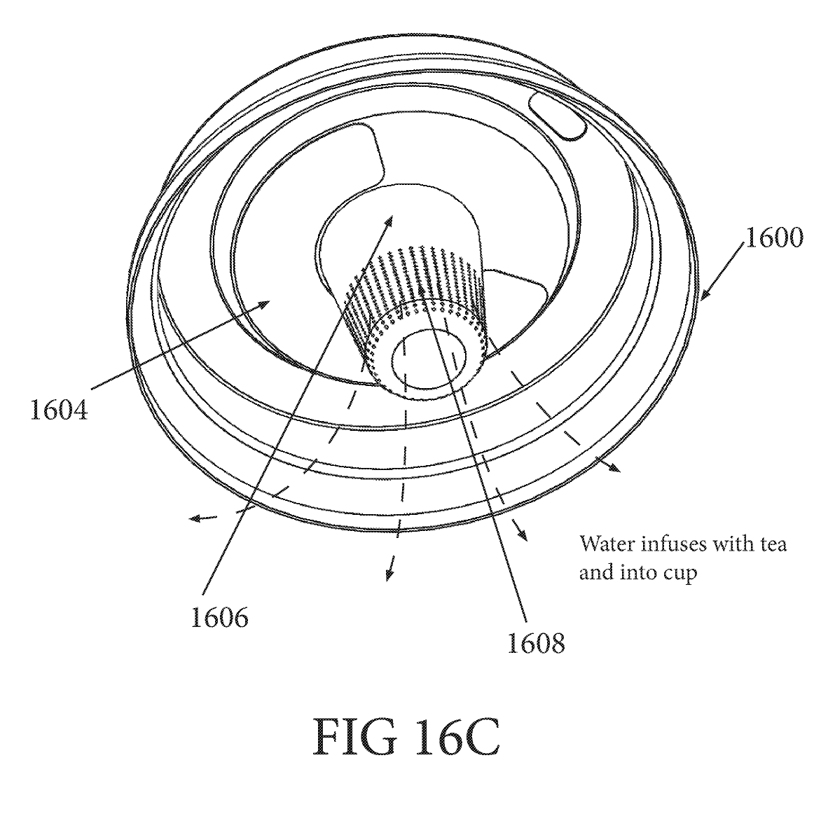

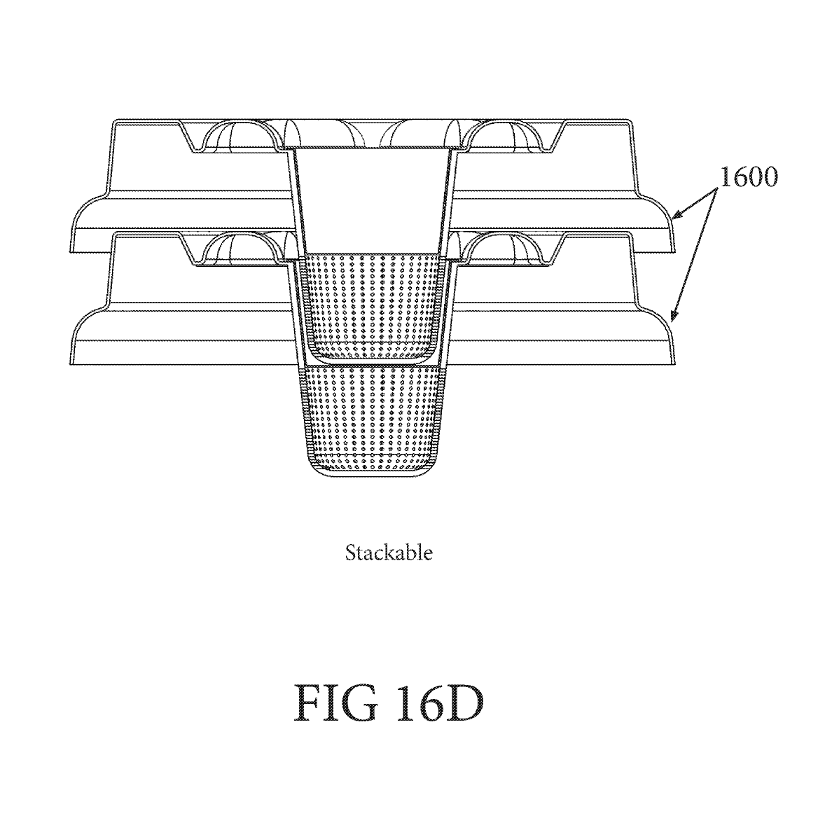

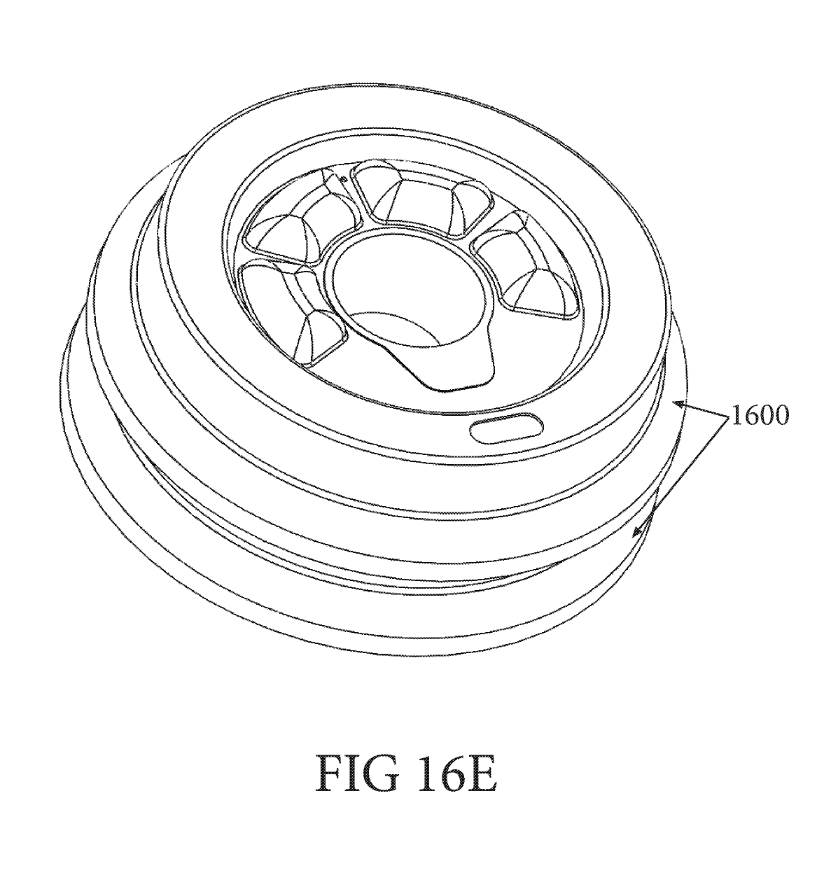

Turning now to FIGS. 16 through 16e, there is shown an alternative embodiment of the invention. The alternative embodiment of a lid 1600 includes a series of compartments being arranged to hold a substance, such as a liquid or a solid. The compartments 1602 are rupturable, so that in use, a user may rupture the compartment 1602 to add the contents of the compartment to a container (not shown). The compartments 1602 may be temporarily sealed by use of a soft and rupturable material, such as foil 1604.

The lid 1600 also includes a central compartment 1606 arranged to extend, in use, into a container. The central compartment 1606 includes filter portion 1608 arranged to allow a user to place a substance into the central compartment 1606 and then filter a liquid through the substance by pouring the liquid into the central compartment 1606.

For example, a user may place tea in the central compartment 1606 and then add water to allow the water to enter the container while being filtered through the tea.

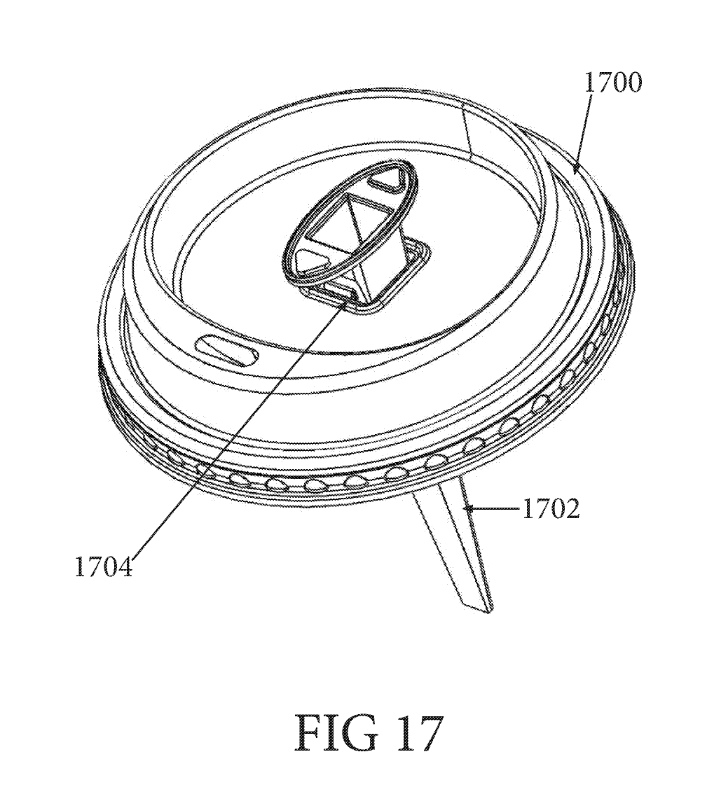

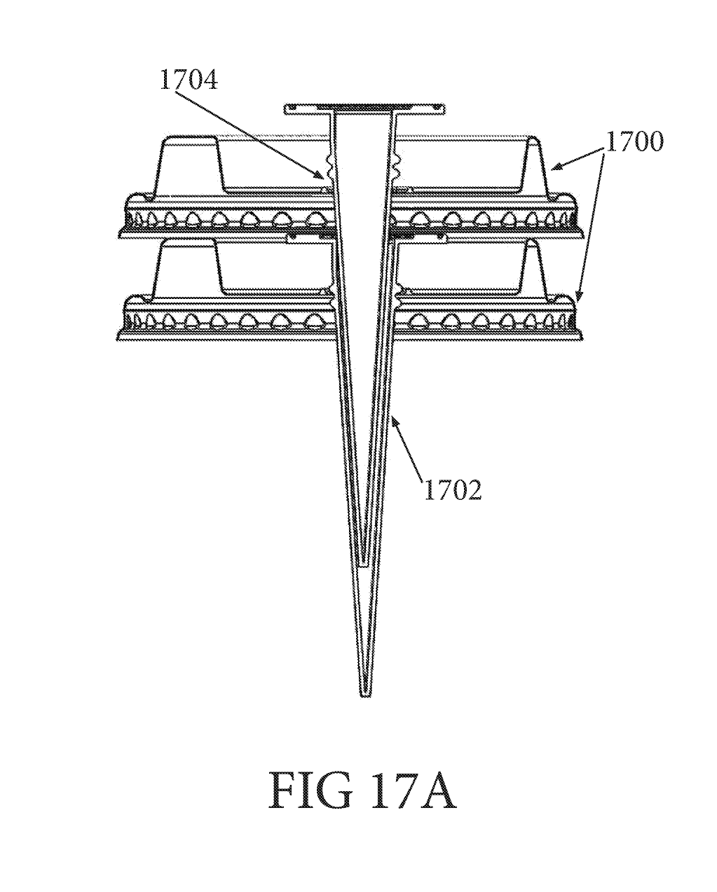

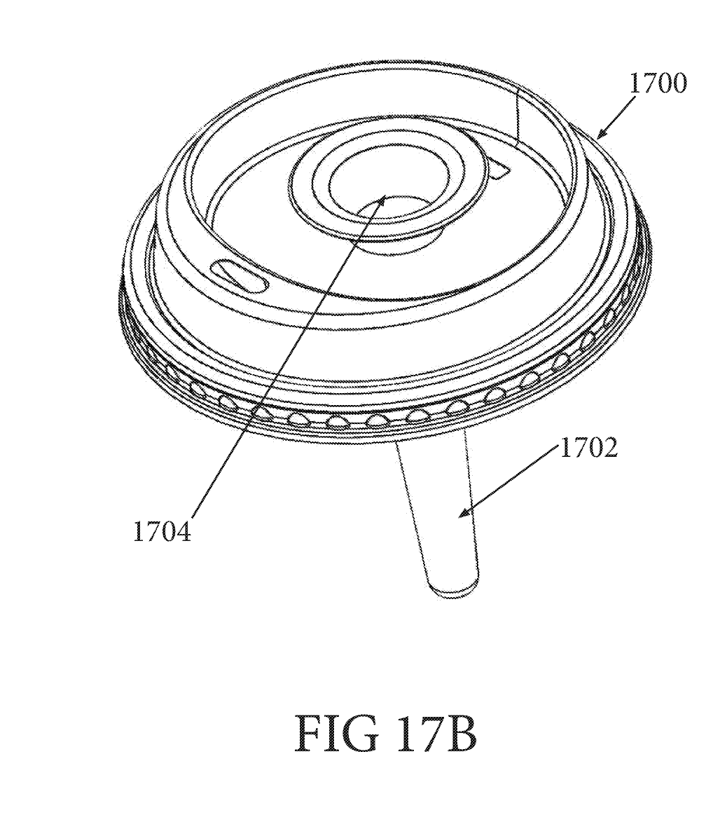

Referring now to FIGS. 17, 17a and 17b, there is shown an embodiment of a lid 1700 that includes a central stirrer 1702 arranged to be inserted through a central opening 1704 in the lid 1700.

It will be understood that the compartments for condiments may be any stuiable size or shape, as required for particular condiment types, or for particular market conditions. It will also be understood that the compartments may be arranged to hold condiments in any suitable form, such as in a powder form, a granular form, in the form of a compressed tablet or capsule form, or in a liquid form.

While the embodiments described herein show and describe particular locations or positions of the compartments relative to other features of the container lid, it will be understood that the exact position of compartments may be varied without departing from the broader inventive concept described and defined herein.

By way of example only, the compartments may be located partially or fully on a top/external lid surface or a bottom/internal lid surface. The compartments may be moulded into the lid surface/material or formed separately and fixed to lid.

The manner in which the compartments are formed may also vary. For example, the compartments may be integrally formed within the lid and sealed with a foil or other waterproof or powder proof covering. In an alternative embodiment, the compartments may also be formed separately and fixed to the lid through a plastics welding process, a gluing process, or any other suitable process.

In an analogous manner, the stirrer may be located (in use or in a ‘stored’ position) in any suitable orientation and in any workable configuration. For example, the stirrer may be positioned on a clip on an external surface o the cup, centrally located and vertically positioned on lid centrally located and compacted until ready for use, in a folded configuration on either an external or internal surface, and may be of an extendable or fixed length.

It will be understood that the container lid may be supplied alone, for fitting to a container, or alternatively, there may be provided a container comprising a body portion and a lid as described herein. Such variations are within the purview of a person skilled in the art.

The container lid may be manufactured in any appropriate manner, including but not limited to moulding the lid portion integrally with the attachment portion, and subsequently securing the arm or two arms to the lid portion such that the arm portion extends from the lid portion.

The embodiments described herein and the broader invention defined herein has application in any situation where beverages or food are sold in a ‘take-away’ or ‘take-out’ situation, or for any situation where a person wishes to transport a beverage from one location to another.

The disposable ‘coffee cup’ and lid market is a mature market and coffee cup manufacturers are always looking to improve their product to make it more attractive to consumers and to the businesses that sell take-away beverages or food. There has been a long felt want for a lid and an associated container that allows a customer to add liquids and solids (such as milk and sugar) to the beverage and stir the beverage without removing the lid of the container.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A lid for a container comprising an attachment portion arranged to attach the lid to the container, a lid portion integrally formed with the attachment portion and sized to substantially cover an opening in the container, at least one opening located on the lid portion to allow the ingress or egress of fluid from the container when the lid is in situ, and at least one arm extending from the lid portion and arranged, in use, to locate within the container to stir the contents of the container.

2. A container lid in accordance with claim 1, wherein the at least one arm extends includes at least one protrusion, wherein the at least one protrusion has a surface area, such that, in use, the surface area is arranged to assist in stirring the contents of the container.

3. A container lid in accordance with claim 1, wherein the arm is attached to a handle wherein a user may operate the handle to operate the arm and in turn stir the contents of the container.

4. A container lid in accordance with claim 3, wherein the protrusion is substantially disc-shaped.

5. A container lid in accordance with claim 4, wherein the protrusion is angled to maximise the area swept by the arm.

6. A container lid in accordance with claim 4, wherein the arm and the protrusion cooperate such that, as the swivel is turned, the protrusion moves along the arm.

7. A container lid in accordance with claim 6, wherein the at least one opening is arranged to receive at least receptacle arranged to, in use, to dispense a substance into the contents of the container.

8. A container lid in accordance with claim 7, further comprising at least one opening arranged to, in use, allow the contents of the container to be dispensed while the lid is secured to the container.

9. A container comprising a body portion and a lid in accordance with claim 1, wherein the lid is arranged to engage with the body portion to provide a substantially sealed container.

10. A method of manufacturing a lid in accordance with claim 1, comprising the steps of moulding the lid portion integrally with the attachment portion, and securing the at least one arm to the lid portion such that the arm portion extends from the lid portion.

11. A lid for a container comprising an attachment portion arranged to attach the lid to the container, a lid portion integrally formed with the attachment portion and sized to substantially cover an opening in the container, at least one opening located on the lid portion to allow the ingress or egress of fluid from the container when the lid is in situ, and another opening arranged, in use, to allow a stirring mechanism to be located through the opening and into the container to stir the contents of the container.

12. A container lid in accordance with claim 11, wherein the stirring mechanism includes at least one arm arranged to extend into the container, and at least one protrusion, wherein the at least one protrusion is arranged to locate the stirring mechanism in the another opening.

13. A container lid in accordance with claim 11, wherein the arm includes a widened portion arranged to assist in the stirring motion when the stirring mechanism is operated.

14. A lid for a container comprising an attachment portion arranged to attach the lid to the container, a lid portion integrally formed with the attachment portion and sized to substantially cover an opening in the container, at least one opening located on the lid portion to allow the ingress or egress of fluid from the container when the lid is in situ, and at least one compartment arranged to contain at least one substance capable of being dispensed into the container.

15. A container lid in accordance with claim 14, wherein the at least one compartment includes a piercing portion arranged to, on pressure being applied by a user, pierce a rupturable portion the compartment to allow the at least one substance to be dispensed into the container.

16. A container lid in accordance with claim 14, wherein the rupturable portion is constructed of a foil-like substance.
